(19) United States
(12) Patent Application Publication
(10) Pub. No.: US 2022/0223859 A1
(43) Pub. Date: Jul. 14, 2022

(54) POSITIVE ELECTRODE LITHIUM SUPPLEMENTING MATERIAL, POSITIVE ELECTRODE CONTAINING POSITIVE ELECTRODE LITHIUM SUPPLEMENTING MATERIAL, AND PREPARATION METHOD THEREOF

(71) Applicant: Ningde Amperex Technology Limited, Ningde City (CN)

(72) Inventor: Molin ZHOU, Ningde (CN)

(73) Assignee: Ningde Amperex Technology Limited, Ningde City (CN)

(21) Appl. No.: 17/708,129

(22) Filed: Mar. 30, 2022

Related U.S. Application Data
(63) Continuation of application No. PCT/CN2019/122055, filed on Nov. 29, 2019.

(30) Foreign Application Priority Data
Nov. 4, 2019 (CN) 201911066794.0

(51) Int. Cl. H01M 4/505; H01M 4/525; H01M 4/62; H01M 10/0525

(52) U.S. Cl. CPC H01M 4/505; H01M 4/525; H01M 2004/028; H01M 4/625; H01M 10/0525; H01M 4/623

(57) ABSTRACT

A positive electrode lithium supplementing material includes at least one of Li₂M1O₂, Li₂M2O₃, Li₅FeₓM3₁₋ₓO₄, or Li₆Mn_{y}M4_{1-y}O₄, where M1 contains at least one of Ni, Mn, Cu, Fe, Cr, or Mo; M2 contains at least one of Ni, Mn, Fe, Mo, Zr, Si, Cu, Cr, or Ru; M3 contains at least one of Al, Nb, Co, Mn, Ni, Mo, Ru, or Cr; and M4 contains at least one of Ni, Fe, Cu, or Ru; where 0≤x≤1 and 0≤y≤1.

### CROSS-REFERENCE TO RELATED APPLICATIONS

This application is a Continuation of PCT/CN2019/122055 filed on Nov. 29, 2019 which claims the benefit of priority from Chinese patent application 201911066794.0 filed on Nov. 4, 2019, the disclosure of which is hereby incorporated by reference in its entirety.

### TECHNICAL FIELD

This application relates to the field of energy storage technologies, and in particular, to a positive electrode lithium supplementing material, a positive electrode containing the positive electrode lithium supplementing material, and a preparation method thereof.

### BACKGROUND

Compared with lead-acid batteries, nickel-cadmium batteries, and nickel-hydrogen batteries, lithium-ion batteries have advantages of high energy density, great power density, high working voltage, good cycle performance, long service life, low self-discharge, a wide temperature adaptation range, and the like. Lithium-ion batteries have been widely applied to the 3C digital field since their commercialization in 1991. However, with the vigorous development of smartphones and electric vehicles, energy density and cycle life of existing lithium-ion batteries are increasingly unable to meet market demands.

The energy density and cycle life of the lithium-ion batteries are closely related to first Coulombic efficiency and formation of a negative electrode solid electrolyte interface (SEI) film. During first charging of a lithium-ion battery, a SEI film formed on a negative electrode surface converts a large amount of active lithium into lithium carbonate, lithium fluoride, and alkyl lithium, resulting in a loss of lithium in a positive electrode material. In a lithium-ion battery system using graphite as a negative electrode, about 10% of a lithium source is consumed for the first charging. When a negative electrode material with a high specific capacity is used, for example, an alloy (silicon, tin, and the like), an oxide (silicon oxide or tin oxide), and amorphous carbon are used as the negative electrode, consumption of the lithium source in the positive electrode increases further.

Pre-lithiation to the positive electrode or the negative electrode is an effective method for increasing energy density of the lithium-ion battery. Studies have shown that it is possible to compensate for capacity loss of the lithium-ion battery during the first charging and discharging by introducing metal lithium or metal lithium salt with relatively high activity. However, existing lithium supplementing materials are mainly stabilized metal lithium powder or organic lithium salt, which are still highly active and cannot be stored stably for a long time, increasing operation difficulty and production risks. In addition, there is also a problem of compatibility between the existing lithium supplementing materials and existing solvents and binders. For example, the stabilized lithium metal powder reacts with a common slurry solvent, N-methylpyrrolidone (NMP).

The positive electrode lithium supplementing material has a high potential, and is well compatible with processing technologies of existing lithium-ion batteries, and safer and easier to operate. Therefore, the positive electrode lithium supplementing material has received increasing attentions from the academic circle and industrial circle. However, the existing positive electrode lithium supplementing materials (such as L-lithium ascorbate, D-lithium erythorbate, lithium metabisulfite, lithium sulfite, lithium phytate, and the like) are easily oxidized in the air and are difficult to synthesize in large quantities, which does not facilitate large-scale industrial production.

### SUMMARY

This application provides a positive electrode lithium supplementing material, a positive electrode containing the positive electrode lithium supplementing material, and a preparation method thereof in an attempt to resolve at least one problem existing in the related field to at least some extent.

According to an embodiment of this application, this application provides a positive electrode lithium supplementing material, including at least one of Li₂M1O₂, Li₂M2O₃, Li₅FeₓM3₁₋ₓO₄, or Li₆Mn_{y}M4_{1-y}O₄, where M1 contains at least one of Ni, Mn, Cu, Fe, Cr, or Mo; M2 contains at least one of Ni, Mn, Fe, Mo, Zr, Si, Cu, Cr, or Ru; M3 contains at least one of Al, Nb, Co, Mn, Ni, Mo, Ru, or Cr; and M4 contains at least one of Ni, Fe, Cu, or Ru; where 0≤x≤1 and 0≤y≤1.

According to an embodiment of this application, a first delithiation capacity of the positive electrode lithium supplementing material is greater than or equal to about 300 mAh/g.

According to an embodiment of this application, a median particle diameter D50 of the positive electrode lithium supplementing material is less than or equal to about 1.5 μm.

According to an embodiment of this application, the positive electrode lithium supplementing material includes at least one of Li₂NiO₂, Li₂MoO₃, Li₅FeO₄, Li₅Fe_{0.9}Al_{0.1}O₄, Li₆MnO₄, or Li₆Mn_{0.5}Ru_{0.5}O₄.

According to an embodiment of this application, this application further provides a positive electrode, where the positive electrode includes a positive electrode lithium supplementing material layer, and the positive electrode lithium supplementing material layer contains any one of the foregoing positive electrode lithium supplementing materials.

According to an embodiment of this application, a thickness of the positive electrode lithium supplementing material layer is less than or equal to about 10 μm.

According to an embodiment of this application, the positive electrode lithium supplementing material layer further includes a conductive agent and a binder, where the binder includes at least one of polypropylene, polyethylene, polyvinylidene fluoride, vinylidene fluoride-hexafluoropropylene, polytetrafluoroethylene, or polyhexafluoropropylene, and the conductive agent includes at least one of conductive carbon black, carbon fiber, acetylene black, Ketjen black, graphene, or carbon nanotube.

According to an embodiment of this application, based on a total weight of the positive electrode lithium supplementing material layer, a weight percentage of the positive electrode lithium supplementing material is about 80 wt % to about 90 wt %, a weight percentage of the binder is about 5 wt % to about 10 wt %, and a weight percentage of the conductive agent is about 5 wt % to about 10 wt %.

According to an embodiment of this application, the positive electrode further includes a positive electrode active material layer, where the positive electrode lithium supplementing material layer is arranged on a current collector, and the positive electrode active material layer is arranged on the positive electrode lithium supplementing material layer.

According to an embodiment of this application, the positive electrode active material layer includes a positive electrode active material, a binder, and a conductive agent, where the positive electrode active material includes at least one of lithium cobalt oxide, lithium iron phosphate, lithium iron manganese phosphate, lithium vanadium phosphate, lithium vanadyl phosphate, lithium vanadate, lithium manganate, lithium nickelate, lithium nickel manganese cobalt oxide, lithium-rich manganese-based material, or lithium nickel cobalt aluminium oxide, the binder includes at least one of fluorine-containing resin, polypropylene resin, a fiber-type binder, a rubber-type binder, or a polyimide-type binder, and the conductive agent includes at least one of conductive carbon black, carbon fiber, acetylene black, Ketjen black, graphene, or a carbon nanotube.

According to an embodiment of this application, based on a total weight of the positive electrode active material layer, a weight percentage of the positive electrode active material is about 80 wt % to about 98 wt %, a weight percentage of the binder is about 0.5 wt % to about 10 wt %, and a weight percentage of the conductive agent is about 0.5 wt % to about 10 wt %.

According to an embodiment of this application, the positive electrode lithium supplementing material in the positive electrode lithium supplementing material layer accounts for about 1 wt % to about 10 wt % of the positive electrode active material in the positive electrode active material layer.

According to an embodiment of this application, this application further provides a method for preparing a positive electrode. The method includes: depositing or applying as a coating, on current collector, any one of the foregoing positive electrode lithium supplementing materials; and drying the current collector on which the positive electrode lithium supplementing material is deposited or applied as a coating, and then applying a positive electrode active material as a coating.

According to an embodiment of this application, this application further provides an electrochemical apparatus, including any one of the foregoing positive electrodes or a positive electrode prepared by the foregoing method.

According to an embodiment of this application, this application further provides an electronic apparatus, including any one of the foregoing electrochemical apparatuses.

Additional aspects and advantages of the embodiments of this application are partially described and presented in subsequent descriptions, or explained by implementation of the embodiments of this application.

### DETAILED DESCRIPTION

Embodiments of this application are described in detail below. The embodiments described herein are illustrative in nature and used to provide a basic understanding of this application. The embodiments of this application shall not be construed as a limitation on this application.

As used herein, terms “approximately”, “basically”, “substantially”, and “about” used herein are intended to describe and illustrate small variations. When used in combination with an event or a circumstance, the term may refer to an example in which an event or circumstance accurately occurs or an example in which an event or circumstance extremely similarly occurs. For example, when used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if a difference between two values is less than or equal to ±10% (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%) of an average value of the values, the two values can be considered to be “basically” the same.

In addition, quantities, ratios, and other values are sometimes presented herein in formats of ranges. It should be understood that such formats of ranges are used for convenience and brevity and should be flexibly understood as including not only values clearly designated as falling within the range but also all individual values or sub-ranges covered by the range as if each value and sub-range are clearly designated.

In the implementations and claims, a list of items connected by terms such as “at least one of”, “at least one type of”, or other similar terms may mean any combination of the listed items. For example, if items A and B are listed, a phrase “at least one of A and B” means only A; only B; or A and B. In another example, if items A, B, and C are listed, a phrase “at least one of A, B, and C” means only A; only B; or only C; A and B (excluding C); A and C (excluding B); B and C (excluding A); or all of A, B, and C. The item A may contain a single element or a plurality of elements. The item B may contain a single element or a plurality of elements. The item C may contain a single element or a plurality of elements.

This application provides a positive electrode lithium supplementing material, a positive electrode containing the positive electrode lithium supplementing material, and a preparation method thereof, and further provides an electrochemical apparatus and an electronic apparatus including the positive electrode.

### I. Positive Electrode Lithium Supplementing Material

This application provides a positive electrode lithium supplementing material, including at least one of Li₂M1O₂, Li₂M2O₃, Li₅FeₓM3₁₋ₓO₄, or Li₆Mn_{y}M4_{1-y}O₄, where M1 contains at least one of Ni, Mn, Cu, Fe, Cr, or Mo; M2 contains at least one of Ni, Mn, Fe, Mo, Zr, Si, Cu, Cr, or Ru; M3 contains at least one of Al, Nb, Co, Mn, Ni, Mo, Ru, or Cr; and M4 contains at least one of Ni, Fe, Cu, or Ru; where 0≤x≤1 and 0≤y≤1.

In some embodiments, the positive electrode lithium supplementing material includes at least one of Li₂NiO₂, Li₂MoO₃, Li₅FeO₄, Li₅Fe_{0.9}Al_{0.1}O₄, Li₆MnO₄, or Li₆Mn_{0.5}Ru_{0.5}O₄. In some embodiments, the positive electrode lithium supplementing material includes Li₅FeO₄. In some embodiments, the positive electrode lithium supplementing material includes Li₂NiO₂. In some embodiments, the positive electrode lithium supplementing material includes Li₆Mn_{0.5}Ru_{0.5}O₄.

In some embodiments, a first delithiation capacity of the positive electrode lithium supplementing material is greater than or equal to about 300 mAh/g. In some embodiments, the first delithiation capacity of the positive electrode lithium supplementing material is greater than or equal to about 350 mAh/g, greater than or equal to about 400 mAh/g, greater than or equal to about 500 mAh/g, or greater than or equal to 600 mAh/g. In some embodiments, the first delithiation capacity of the positive electrode lithium supplementing material is about 300 mAh/g to about 350 mAh/g, about 300 mAh/g to about 400 mAh/g, about 300 mAh/g to about 500 mAh/g, or about 300 mAh/g to about 600 mAh/g, or the like.

In some embodiments, a median particle diameter D50 of the positive electrode lithium supplementing material is less than or equal to about 1.5 μm. In some embodiments, the median particle diameter D50 of the positive electrode lithium supplementing material is less than or equal to 1.2 μm, less than or equal to about 1 μm or less than or equal to about 0.5 μm. In some embodiments, the median particle diameter D50 of the positive electrode lithium supplementing material is about 0.5 μm to about 1.5 μm, about 1 μm to about 1.5 μm, about 0.1 μm to about 1.5 μm, or the like.

### II. Positive Electrode

This application provides a positive electrode, including a positive electrode lithium supplementing material layer. The positive electrode lithium supplementing material layer contains any one of the foregoing positive electrode lithium supplementing materials.

In some embodiments, based on a total weight of the positive electrode lithium supplementing material layer, a weight percentage of the positive electrode lithium supplementing material is about 80 wt % to about 90 wt %. In some embodiments, based on a total weight of the positive electrode lithium supplementing material layer, a weight percentage of the positive electrode lithium supplementing material is about 80 wt % to about 85 wt %, about 80 wt % to about 90 wt %, or about 85 wt % to about 90 wt %, or the like.

In some embodiments, a thickness of the positive electrode lithium supplementing material layer is less than or equal to about 10 μm. In some embodiments, the thickness of the positive electrode lithium supplementing material layer is less than or equal to about 5 μm, less than or equal to about 3 nm, or less than or equal to about 1 nm. In some embodiments, the thickness of the positive electrode lithium supplementing material layer is about 5 μm to about 10 μm, about 1 μm to about 5 μm, about 1 μm to about 10 μm, or about 3 μm to about 10 μm, or the like.

In some embodiments, the positive electrode lithium supplementing material layer further contains a binder. In some embodiments, the binder includes at least one of polypropylene, polyethylene, polyvinylidene fluoride (PVDF), vinylidene fluoride-hexafluoropropylene, polytetrafluoroethylene, or polyhexafluoropropylene. In some embodiments, the binder in the positive electrode lithium supplementing material layer includes the polyvinylidene fluoride.

In some embodiments, based on a total weight of the positive electrode lithium supplementing material layer, a weight percentage of the binder is about 5 wt % to about 10 wt %. In some embodiments, based on the total weight of the positive electrode lithium supplementing material layer, the weight percentage of the binder is about 5 wt % to about 7 wt % or about 7 wt % to about 10 wt %, or the like.

In some embodiments, the positive electrode lithium supplementing material layer further includes a conductive agent. In some embodiments, the conductive agent includes at least one of conductive carbon black (SP), carbon fiber, acetylene black, Ketjen black, graphene, or a carbon nanotube (CNT). In some embodiments, the conductive agent in the positive electrode lithium supplementing material layer includes the carbon nanotube.

In some embodiments, based on the total weight of the positive electrode lithium supplementing material layer, a weight percentage of the conductive agent is about 5 wt % to about 10 wt %. In some embodiments, based on the total weight of the positive electrode lithium supplementing material layer, the weight percentage of the conductive agent is about 5 wt % to about 7 wt % or about 7 wt % to about 10 wt %, or the like.

In some embodiments, the positive electrode further includes a positive electrode active material layer, where the positive electrode lithium supplementing material layer is arranged on a current collector, and the positive electrode active material layer is arranged on the positive electrode lithium supplementing material layer. In some embodiments, the current collector may be, but is not limited to, aluminum (Al).

In some embodiments, the positive electrode active material layer contains a positive electrode active material, a binder, and a conductive agent. In some embodiments, the positive electrode active material includes at least one of lithium cobalt oxide (LiCoO₂), lithium iron phosphate, lithium iron manganese phosphate, lithium vanadium phosphate, lithium vanadyl phosphate, lithium vanadate, lithium manganate, lithium nickelate, lithium nickel manganese cobalt oxide, lithium-rich manganese-based material or lithium nickel cobalt aluminium oxide. In some embodiments, the positive electrode active material includes lithium cobalt oxide with a cut-off voltage greater than or equal to about 4.45 V.

In some embodiments, the binder in the positive electrode active material layer includes at least one of fluorine-containing resin, polypropylene resin, fiber-type binder, rubber-type binder or polyimide-type binder. In some embodiments, the binder in the positive electrode active material layer includes polyvinylidene fluoride.

In some embodiments, the conductive agent in the positive electrode active material layer includes at least one of conductive carbon black, carbon fiber, acetylene black, Ketjen black, graphene, or carbon nanotube. In some embodiments, the conductive agent in the positive electrode active material layer includes the conductive carbon black.

In some embodiments, based on a total weight of the positive electrode active material layer, a weight percentage of the positive electrode active material is about 80 wt % to about 98 wt %. In some embodiments, based on the total weight of the positive electrode active material layer, the weight percentage of the positive electrode active material is about 80 wt % to about 85 wt %, about 80 wt % to about 90 wt %, about 85 wt % to about 95 wt %, or about 85 wt % to about 98 wt %, or the like.

In some embodiments, based on the total weight of the positive electrode active material layer, a weight percentage of the binder is about 0.5 wt % to about 10 wt %. In some embodiments, based on the total weight of the positive electrode active material layer, the weight percentage of the binder is about 0.5 wt % to about 5 wt %, about 1 wt % to about 5 wt %, about 5 wt % to about 10 wt %, or about 1 wt % to about 10 wt %, or the like.

In some embodiments, based on the total weight of the positive electrode active material layer, a weight percentage of the conductive agent is about 0.5 wt % to about 10 wt %. In some embodiments, based on the total weight of the positive electrode active material layer, the weight percentage of the conductive agent is about 0.5 wt % to about 5 wt %, about 1 wt % to about 5 wt %, about 5 wt % to about 10 wt %, or about 1 wt % to about 10 wt %, or the like.

In some embodiments, the positive electrode lithium supplementing material in the positive electrode lithium supplementing material layer accounts for about 1 wt % to about 10 wt % of the positive electrode active material in the positive electrode active material layer. In some embodiments, the positive electrode lithium supplementing material in the positive electrode lithium supplementing material layer accounts for about 1 wt % to about 2 wt %, about 1 wt % to about 5 wt %, about 2 wt % to about 5 wt %, about 5 wt % to about 10 wt % or the like of the positive electrode active material in the positive electrode active material layer.

### III. Method for Preparing a Positive Electrode

This application further provides a method for preparing a positive electrode. The method includes: depositing or applying as a coating, on a current collector, the positive electrode lithium supplementing material of this application; and drying the current collector on which the positive electrode lithium supplementing material is deposited or applied as a coating, and then applying a positive electrode active material as a coating to prepare the positive electrode.

In the preparation method of this application, the current collector is first coated with the positive electrode lithium supplementing material layer (coating or deposit), and a particle size of the positive electrode lithium supplementing material and a thickness of the positive electrode lithium supplementing material layer are strictly controlled to reduce polarization of the positive electrode lithium supplementing material layer. In one aspect, during a first cycle of charging, the positive electrode lithium supplementing material finishes complete delithiation and releases lithium ions to supplement active lithium consumed by a negative electrode SEI film, which improves a reversible capacity and energy density of an electrochemical apparatus. In another aspect, after delithiation of the positive electrode lithium supplementing material, a delithiated product with poor conductivity is left to cover the current collector, which can greatly reduce a risk of micro short circuiting caused by nail penetration, and improve safety of the electrochemical apparatus (especially a lithium-ion battery with high energy density).

In this application, the double-layer coating or deposition method is used, which can improve both the energy density and safety of the electrochemical apparatus. The delithiated product of the positive electrode lithium supplementing material of this application has a stable structure, and an isolation layer formed in situ on the current collector after delithiation in the first cycle can greatly reduce a risk of a battery nail penetration failure. In addition, the method for preparing the positive electrode of this application is simple and easy for commercial production.

### IV. Electrochemical Apparatus

The electrochemical apparatus of this application includes any one of the foregoing positive electrodes of this application. The electrochemical apparatus of this application may include any apparatus in which an electrochemical reaction occurs. Specific examples of the electrochemical apparatus include all types of primary batteries, secondary batteries, fuel batteries, solar batteries, or capacitors. Especially, the electrochemical apparatus is a lithium secondary battery, including a lithium metal secondary battery, a lithium-ion secondary battery, a lithium polymer secondary battery, or a lithium-ion polymer secondary battery. In some embodiments, the electrochemical apparatus of this application includes the positive electrode of this application, a negative electrode, a separator disposed between the positive electrode and the negative electrode, and an electrolyte. In some embodiments, the electrochemical apparatus is a lithium-ion battery.

In some embodiments, the negative electrode includes a negative electrode current collector and a negative electrode active material layer located on the negative electrode current collector. The negative electrode active material includes a material that reversibly intercalates and deintercalates lithium ions. In some embodiments, the material that reversibly intercalates and deintercalates lithium ions includes a carbon material. In some embodiments, the carbon material may be any carbon-based negative electrode active material commonly used in a lithium-ion rechargeable battery. In some embodiments, the carbon material includes, but is not limited to: crystalline carbon, amorphous carbon, or a mixture thereof. The crystalline carbon may be amorphous, flake-shaped, small flake-shaped, spherical, or fibrous natural graphite or artificial graphite. The amorphous carbon may be soft carbon, hard carbon, mesophase pitch carbide, calcined coke, or the like.

In some embodiments, the negative electrode active material includes, but is not limited to: lithium metal, structured lithium metal, natural graphite, artificial graphite, mesophase carbon microbeads (MCMB), hard carbon, soft carbon, silicon, silicon oxide (SiOₓ), silicon-carbon composite, Li—Sn alloy, Li—Sn—O alloy, Sn, SnO, SnO₂, lithiated TiO₂—Li₄Ti₅O₁₂ of a spinel structure, Li—Al alloy, or any combination thereof.

When the negative electrode includes the silicon-carbon compound, based on a total weight of the negative electrode active material, silicon:carbon=about 1:10 to 10:1, and a median particle diameter D50 of the silicon-carbon compound is about 0.1 μm to 100 μm. When the negative electrode includes an alloy material, a negative electrode active material layer may be formed by using methods such as a vapor deposition method, a sputtering method, and a plating method. When the negative electrode includes a lithium metal, for example, the negative electrode active material layer is formed by using a conductive skeleton having a spherically twisted shape and metal particles dispersed in the conductive skeleton. In some embodiments, the spherically twisted conductive skeleton may have a porosity of about 5% to about 85%. In some embodiments, a protective layer may be further disposed on a lithium-metal negative electrode active material layer.

In some embodiments, the negative electrode may further include a binder. The binder improves bonding between the negative electrode active material particles and bonding between the negative electrode active material and the negative electrode current collector. In some embodiments, the binder includes, but is not limited to: polyvinyl alcohol, carboxymethyl cellulose, hydroxypropyl cellulose, diacetyl cellulose, polyvinyl chloride, carboxylated polyvinyl chloride, polyfluoroethylene ethylene, polymer containing ethylene oxide, polyvinylpyrrolidone, polyurethane, polytetrafluoroethylene, 1,1-polyvinylidene fluoride, polyethylene, polypropylene, polyacrylic acid (PAA), styrene butadiene rubber, acrylic (esterified) styrene butadiene rubber, epoxy resin, nylon, and the like.

In some embodiments, the negative electrode may further include a conductive agent. The conductive agent includes, but is not limited to: a carbon-based material, a metal-based material, a conductive polymer, or a mixture thereof. In some embodiments, the carbon-based material is selected from natural graphite, artificial graphite, conductive carbon black, acetylene black, Ketjen black, carbon fiber, or any combination thereof. In some embodiments, the metal-based material is selected from metal powder, metal fiber, copper, nickel, aluminum, silver. In some embodiments, the conductive polymer is a polyphenylene derivative.

In some embodiments, the negative electrode current collector includes, but is not limited to: copper (Cu) foil, nickel foil, stainless steel foil, titanium foil, nickel foam, copper foam, a polymer substrate coated with a conductive metal, and any combination thereof.

The negative electrode can be prepared by using a preparation method known in the art. For example, the negative electrode may be obtained by using the following method: mixing an active material, a conductive material, and a binder in a solvent to prepare an active material composition, and coating the current collector with the active material composition. In some embodiments, the solvent may include, but is not limited to, water and the like.

In some embodiments, the separator includes, but is not limited to, at least one selected from polyethylene, polypropylene, polyethylene terephthalate, polyimide, and aramid. For example, the polyethylene includes at least one component selected from high-density polyethylene, low-density polyethylene, and ultra-high molecular weight polyethylene. Especially the polyethylene and the polypropylene, which perform well in preventing short circuiting, and can improve stability of lithium-ion batteries through a turn-off effect.

In some embodiments, the electrolyte may be one or more of a gel electrolyte, a solid electrolyte, and a liquid electrolyte. The electrolyte includes a lithium salt and a non-aqueous solvent.

In some embodiments, the lithium salt may be selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, LiPF₆ is selected as the lithium salt because LiPF₆ can provide high ionic conductivity and improve cycle performance.

In some embodiments, the non-aqueous solvent may be a carbonate compound, a carboxylate compound, an ether compound, other organic solvents, or a combination thereof.

In some embodiments, the carbonate compound may be a chain carbonate compound, a cyclic carbonate compound, a fluorocarbonate compound, or a combination thereof.

In some embodiments, an example of the chain carbonate compound is diethyl carbonate (DEC), dimethyl carbonate (DMC), dipropyl carbonate (DPC), methyl propyl carbonate (MPC), ethylene propyl carbonate (EPC), ethyl methyl carbonate (MEC), or a combination thereof. An example of the cyclic carbonate compound is ethylene carbonate (EC), propylene carbonate (PC), butylene carbonate (BC), vinyl ethylene carbonate (VEC), or a combination thereof. An example of the fluorocarbonate compound is fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

In some embodiments, an example of the carboxylate compound is methyl acetate, ethyl acetate, n-propyl acetate, tert-butyl acetate, methyl propionate, ethyl propionate, propyl propionate, γ-butyrolactone, decalactone, valerolactone, mevalonolactone, caprolactone, methyl formate, or a combination thereof.

In some embodiments, an example of the ether compound is dibutyl ether, tetraglyme, diglyme, 1,2-dimethoxyethane, 1,2-diethoxyethane, ethoxymethoxyethane, 2-methyltetrahydrofuran, tetrahydrofuran, or a combination thereof.

In some embodiments, an example of another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or a combination thereof.

### V. Application

An electrochemical apparatus manufactured by using the positive electrode described in this application is applicable to electronic apparatuses in various fields.

Use of the electrochemical apparatus of this application is not particularly limited, and may be used for any purpose known in the prior art. In one embodiment, the electrochemical apparatus of this application may be used with limitation in notebook computers, pen-input computers, mobile computers, electronic book players, portable telephones, portable fax machines, portable copiers, portable printers, stereo headsets, video recorders, liquid crystal televisions, portable cleaners, portable CD players, mini-disc players, transceivers, electronic notebooks, calculators, storage cards, portable recorders, radios, backup power sources, motors, automobiles, motorcycles, motor bicycles, bicycles, lighting appliances, toys, game machines, clocks, electric tools, flash lamps, cameras, large household batteries, lithium-ion capacitors, and the like.

### VI. Examples

Below, this application is further specifically described with examples and comparative examples, but this application is not limited to these examples as long as the essence of this application is not changed.

### Example 1

Step 1: Dissolve LiCoO₂, PVDF, and SP in NMP at a weight ratio of LiCoO₂:PVDF:SP=90:5:5, and stir it evenly to obtain a positive electrode active material layer slurry.

Step 2: Dissolve Li₅FeO₄, PVDF, and CNT in NMP at a weight ratio of Li₅FeO₄:PVDF:CNT=90:5:5, and stir it evenly to obtain a positive electrode lithium supplementing material layer slurry, where a median particle diameter D50 of Li₅FeO₄ was 1.5 μm and accounted for about 1 wt % of LiCoO₂ in the positive electrode active material layer.

Step 3: First spray the positive electrode lithium supplementing material layer slurry on a surface of an Al current collector, dry and roll the slurry to control a thickness thereof to be 5 μm, then coat the positive electrode lithium supplementing material layer with the positive electrode active material layer slurry, and dry them to obtain a lithium-supplemented positive electrode plate with a double-layer structure.

Step 4: Dissolve in deionized water at a weight ratio of SiOₓ(0.5<x<1.6):PAA:SP=90:5:5, stir it evenly to obtain a negative electrode slurry, coat a surface of a Cu current collector with the negative electrode slurry, and try them to obtain a negative electrode plate.

Step 5: Roll, cut, laminate, inject liquid into, and encapsulate the positive electrode plate and the negative electrode plate prepared above to obtain a soft-packaged lithium-ion battery.

A capacity test and a nail penetration test were implemented on the lithium-ion battery.

### Example 2

The lithium-ion battery was prepared using the method in Example 1, and a capacity test and a nail penetration test were performed.

A difference of Example 2 from Example 1 is that: a ratio in step 2 was Li₅FeO₄:PVDF:CNT=80:10:10, and Li₅FeO₄ accounted for about 5% by weight of LiCoO₂ in the positive electrode active material layer; and a thickness of the positive electrode lithium supplementing material layer in step 3 was controlled to be 7 μm.

### Example 3

The lithium-ion battery was prepared using the method in Example 1, and a capacity test and a nail penetration test were performed.

A difference of Example 3 from Example 1 is that: Li₅FeO₄ in step 2 accounted for about 10 wt % of LiCoO₂ in the positive electrode active material layer; and the thickness of the positive electrode lithium supplementing material layer in step 3 was controlled to be 10 μm.

### Example 4

The lithium-ion battery was prepared using the method in Example 1, and a capacity test and a nail penetration test were performed.

A difference of Example 4 from Example 1 is that: the negative electrode active material in step 4 was graphite.

### Example 5

The lithium-ion battery was prepared using the method in Example 2, and a capacity test and a nail penetration test were performed.

A difference of Example 5 from Example 2 is that: Li₅FeO₄ in step 2 accounted for about 2 wt % of LiCoO₂ in the positive electrode active material layer; and the negative electrode active material in step 4 was graphite.

### Example 6

The lithium-ion battery was prepared using the method in Example 3, and a capacity test and a nail penetration test were performed.

A difference of Example 6 from Example 3 is that: Li₅FeO₄ in step 2 accounted for about 5 wt % of LiCoO₂ in the positive electrode active material layer; and the negative electrode active material in step 4 was graphite.

### Example 7

The lithium-ion battery was prepared using the method in Example 1, and a capacity test and a nail penetration test were performed.

A difference of Example 7 from Example 1 is that: in step 2, the lithium supplementing material was Li₂NiO₂, with a median particle diameter D50 of 1.0 μm, which accounted for about 10 wt % of LiCoO₂ in the positive electrode active material layer.

### Example 8

The lithium-ion battery was prepared using the method in Example 1, and a capacity test and a nail penetration test were performed.

A difference of Example 8 from Example 1 is that: in step 2, the lithium supplementing material was Li₆Mn_{0.5}Ru_{0.5}O₄, with a median particle diameter D50 of 1.2 μm, which accounted for about 4 wt % of LiCoO₂ in the positive electrode active material layer, and in step 4, the negative electrode active material was graphite.

### Comparative Example 1

Step 1: Dissolve LiCoO₂, PVDF, and SP in NMP at a weight ratio of LiCoO₂:PVDF:SP=90:5:5, stir it evenly to obtain a positive electrode active material layer slurry, coat a surface of an Al current collector with the positive electrode active material layer slurry, and dry them to obtain a positive electrode plate.

Step 2: Dissolve SiOₓ (0.5<x<1.6), PAA, and SP in deionized water at a weight ratio of SiOₓ (0.5<x<1.6):PAA:SP=90:5:5, stir it evenly to obtain a negative electrode slurry, coat a surface of a Cu current collector with the negative electrode slurry, and dry them to obtain a negative electrode plate.

Step 3: Roll, cut, laminate, inject liquid into, and package the positive electrode plate and the negative electrode plate to obtain a soft-packaged lithium-ion battery.

A capacity test and a nail penetration test were implemented on the lithium-ion battery.

### Comparative Example 2

A lithium-ion battery was prepared through the method in Comparative Example 1, and the capacity test and the nail penetration test were performed.

A difference of Comparative Example 2 from Comparative Example 1 is that: a negative electrode active material in step 2 was graphite.

### Comparative Example 3

A lithium-ion battery was prepared through the method in Comparative Example 1, and the capacity test and the nail penetration test were performed.

A difference of Comparative Example 3 from Comparative Example 1 is that: LiCoO₂ and Li₅FeO₄ were mixed at a ratio of LiCoO₂:Li₅FeO₄=100:1 and then one-time coating was performed, that is, components in step 1 were at a ratio of LiCoO₂:Li₅FeO₄:PVDF:SP=89.1:0.9:5:5.

### Comparative Example 4

A lithium-ion battery was prepared through the method in Comparative Example 1, and the capacity test and the nail penetration test were performed.

A difference of Comparative Example 4 from Comparative Example 1 is that: LiCoO₂ and Li₅FeO₄ were mixed at a ratio of LiCoO₂:Li₅FeO₄=100:5 and then one-time coating was performed, that is, the components in step 1 were at a ratio of LiCoO₂:Li₅FeO₄:PVDF:SP=85.7:4.3:5:5.

### Comparative Example 5

A lithium-ion battery was prepared through the method in Comparative Example 1, and the capacity test and the nail penetration test were performed.

A difference of Comparative Example 5 from Comparative Example 1 is that: in Comparative Example 5, LiCoO₂ and Li₅FeO₄ were mixed at a ratio of LiCoO₂:Li₅FeO₄=100:10 and then one-time coating was performed, that is, components in step 1 were at a ratio of LiCoO₂:Li₅FeO₄:PVDF:SP=81.8:8.2:5:5.

### Comparative Example 6

A lithium-ion battery was prepared through the method in Comparative Example 3, and the capacity test and the nail penetration test were performed.

A difference of Comparative Example 6 from Comparative Example 3 is that: a negative electrode active material in step 2 was graphite.

### Comparative Example 7

A lithium-ion battery was prepared through the method in Comparative Example 1, and the capacity test and the nail penetration test were performed.

A difference of Comparative Example 7 from Comparative Example 1 is that: LiCoO₂ and Li₅FeO₄ were mixed at a ratio of LiCoO₂:Li₅FeO₄=100:2 and then one-time coating was performed, that is, components in step 1 were at a ratio of LiCoO₂:Li₅FeO₄:PVDF:SP=88.2:1.8:5:5.

A negative electrode active material in step 2 was graphite.

### Comparative Example 8

A lithium-ion battery was prepared through the method in Comparative Example 4, and the capacity test and the nail penetration test were performed.

A difference of Comparative Example 8 from Comparative Example 4 is that: a negative electrode active material in step 2 was graphite.

### Comparative Example 9

A lithium-ion battery was prepared through the method in Comparative Example 5, and the capacity test and the nail penetration test were performed.

A difference of Comparative Example 9 from Comparative Example 5 is that: in Comparative Example 9, LiCoO₂ and Li₂NiO₂ were mixed at a ratio of LiCoO₂:Li₂NiO₂=100:10 and then one-time coating was performed, that is, components in step 1 were at a ratio of LiCoO₂:Li₂NiO₂:PVDF:SP=81.8:8.2:5:5.

### Comparative Example 10

A lithium-ion battery was prepared through the method in Comparative Example 1, and the capacity test and the nail penetration test were performed.

A difference of Comparative Example 10 from Comparative Example 1 is that: in Comparative Example 10, LiCoO₂ and Li₆Mn_{0.5}Ru_{0.5}O₄ were mixed at a ratio of LiCoO₂:Li₆Mn_{0.5}Ru_{0.5}O₄=100:4 and then one-time coating was performed, that is, components in step 1 were at a ratio of LiCoO₂:Li₆Mn_{0.5}Ru_{0.5}O₄:PVDF:SP=86.5:3.5:5:5.

A negative electrode active material in step 2 was graphite.

### VII. Test Method and Test Result

Capacity Test

A to-be-tested lithium-ion battery was placed in an environment of 25±3° C. for 30 minutes, the to-be-tested lithium-ion battery was charged to a voltage of 4.45 V (rated voltage) at a constant current rate of 0.05 C (a theoretical gram capacity of a positive electrode active material LiCoO₂ is considered as 185 mAh/g), then the to-be-tested lithium-ion battery was charged to a current of 0.025 C (cut-off current) at a constant voltage, the to-be-tested lithium-ion battery was kept still for 5 minutes, the to-be-tested lithium-ion battery was discharged to a voltage of 3.0 V at a constant current rate of 0.05 C, and specific discharge capacity and coulomb efficiency were recorded in a first cycle.

Specific discharge capacity=Discharge capacity/Weight of a positive electrode active material (lithium cobalt oxide).

Nail Penetration Test

The to-be-tested lithium-ion battery was charged to a voltage of 4.45 V (rated voltage) at a constant current rate of 0.05 C (a theoretical gram capacity of the positive electrode active material LiCoO₂ is 185 mAh/g), and then the to-be-tested lithium-ion battery was charged to a current of 0.025 C (cut-off current) at a constant voltage, so that the battery was charged fully, and an appearance of the battery prior to the test was recorded. The nail penetration test was performed on the battery in an environment of 25±3° C., where a diameter of a steel nail was 4 mm, a penetration speed was 30 mm/s, and nail penetration positions were located respectively at a shallow pit surface with a distance of 15 mm to an edge of an Al Tab (tab) battery cell and with a distance of 15 mm to an edge of an Ni Tab battery cell, the test was stopped after the test was implemented for 3.5 min or a surface temperature of the battery cell dropped to 50° C., 10 battery cells were taken as a group, a battery status was observed during the test, and it was determined that a battery passed the nail penetration test according to a criterion that the battery does not burn or explode and a pass rate is greater than or equal to 90%.

Table 1 shows positive and negative electrode compositions and test results of Example 1 to Example 8 and Comparative Example 1 to Comparative Example 10.

TABLE 1

| | | | Specific | Coulomb | Pass rate |
|---|---|---|---|---|---|
| | | | discharge | efficiency | of nail |
| | | | capacity | in first | penetration |
| Example | Positive electrode | Negative electrode | (mAh/g) | cycle | test |
| Comparative Example 1 | LiCoO₂:PVDF:SP = 90:5:5 | SiOₓ:PAA:SP = 90:5:5 | 151.2 | 80.2% | 0/10 |
| Comparative Example 2 | LiCoO₂:PVDF:SP = 90:5:5 | Graphite:PAA:SP = 90:5:5 | 168.7 | 89.5% | 0/10 |
| Comparative Example 3 | LiCoO₂:Li₅FeO₄:PVDF:SP = 89.1:0.9:5:5 | SiOₓ:PAA:SP = 90:5:5 | 156.8 | 80.6% | 0/10 |
| Comparative Example 4 | LiCoO₂:Li₅FeO₄:PVDF:SP = 85.7:4.3:5:5 | SiOₓ:PAA:SP = 90:5:5 | 179.3 | 82.1% | 1/10 |
| Comparative Example 5 | LiCoO₂:Li₅FeO₄:PVDF:SP = 81.8:8.2:5:5 | SiOₓ:PAA:SP = 90:5:5 | 181.0 | 72.8% | 0/10 |
| Comparative Example 6 | LiCoO₂:Li₅FeO₄:PVDF:SP = 89.1:0.9:5:5 | Graphite:PAA:SP = 90:5:5 | 174.5 | 89.7% | 1/10 |
| Comparative Example 7 | LiCoO₂:Li₅FeO₄:PVDF:SP = 88.2:1.8:5:5 | Graphite:PAA:SP = 90:5:5 | 180.3 | 89.9% | 1/10 |
| Comparative Example 8 | LiCoO₂:Li₅FeO₄:PVDF:SP = 85.7:4.3:5:5 | Graphite:PAA:SP = 90:5:5 | 181.0 | 82.8% | 0/10 |
| Comparative Example 9 | LiCoO₂:Li₂NiO₂:PVDF:SP = 81.8:8.2:5:5 | SiOₓ:PAA:SP = 90:5:5 | 177.4 | 81.2% | 0/10 |
| Comparative Example 10 | LiCoO₂:Li₆Mn_{0.5}Ru_{0.5}O₄:PVDF:SP = 86.5:3.5:5:5 | Graphite:PAA:SP = 90:5:5 | 181.0 | 89.4% | 1/10 |
| Example 1 | Li₅FeO₄:PVDF:CNT = 90:5:5 (first coat) | SiOₓ:PAA:SP = 90:5:5 | 157.2 | 80.8% | 10/10 |
| | LiCoO₂:PVDF:SP = 90:5:5 | | | | |
| | (Li₅FeO₄:LiCoO₂ = 1:100) | | | | |
| Example 2 | Li₅FeO₄:PVDF:CNT = 90:5:5 (first coat) | SiOₓ:PAA:SP = 90:5:5 | 181.0 | 82.4% | 10/10 |
| | LiCoO₂:PVDF:SP = 90:5:5 | | | | |
| | (Li₅FeO₄:LiCoO₂ = 5:100) | | | | |
| Example 3 | Li₅FeO₄:PVDF:CNT = 90:5:5 (first coat) | SiOₓ:PAA:SP = 90:5:5 | 181.0 | 72.9% | 10/10 |
| | LiCoO₂:PVDF:SP = 90:5:5 | | | | |
| | (Li₅FeO₄:LiCoO₂ = 10:100) | | | | |
| Example 4 | Li₅FeO₄:PVDF:CNT = 90:5:5 (first coat) | Graphite:PAA:SP = 90:5:5 | 174.5 | 89.9% | 10/10 |
| | LiCoO₂:PVDF:SP = 90:5:5 | | | | |
| | (Li₅FeO₄:LiCoO₂ = 1:100) | | | | |
| Example 5 | Li₅FeO₄:PVDF:CNT = 90:5:5 (first coat) | Graphite:PAA:SP = 90:5:5 | 180.3 | 90.1% | 10/10 |
| | LiCoO₂:PVDF:SP = 90:5:5 | | | | |
| | (Li₅FeO₄:LiCoO₂ = 2:100) | | | | |
| Example 6 | Li₅FeO₄:PVDF:CNT = 90:5:5 (first coat) | Graphite:PAA:SP = 90:5:5 | 181.0 | 83.1% | 10/10 |
| | LiCoO₂:PVDF:SP = 90:5:5 | | | | |
| | (Li₅FeO₄:LiCoO₂ = 5:100) | | | | |
| Example 7 | Li₂NiO₂:PVDF:CNT = 90:5:5 (first coat) | SiOₓ:PAA:SP = 90:5:5 | 177.6 | 81.3% | 10/10 |
| | LiCoO₂:PVDF:SP = 90:5:5 | | | | |
| | (Li₂NiO₂:LiCoO₂ = 10:100) | | | | |
| Example 8 | Li₆Mn_{0.5}Ru_{0.5}O₄:PVDF:CNT = 90:5:5 (first coat) | Graphite:PAA:SP = 90:5:5 | 181.0 | 89.3% | 10/10 |
| | LiCoO₂:PVDF:SP = 90:5:5 | | | | |
| | (Li₆Mn_{0.5}Ru_{0.5}O₄:LiCoO₂ = 4:100) | | | | |

The positive electrode lithium supplementing material Li₅FeO₄ was not added to positive electrodes in Comparative Example 1 and Comparative Example 2. The negative electrode active material of Comparative Example 3 to Comparative Example 5 was silicon oxide, and positive electrode lithium supplementing materials Li₅FeO₄ accounting for 1 wt %, 5 wt %, and 10 wt % the positive electrode active material were respectively added to corresponding positive electrodes. The negative electrode active material of Comparative Example 6 to Comparative Example 8 was graphite, and positive electrode lithium supplementing materials Li₅FeO₄ accounting for 1 wt %, 2 wt %, and 5 wt % the positive electrode active material were respectively added to corresponding positive electrodes. Positive electrode lithium supplementing materials Li₂NiO₂ accounting for 10 wt % the positive electrode active material were added to the positive electrode in Comparative Example 9, and the negative electrode active material was silicon oxide. The positive electrode lithium supplementing material Li₆Mn_{0.5}Ru_{0.5}O₄ accounting for 4 wt % the positive electrode active material was added to the positive electrode in Comparative Example 10, and the negative electrode active material was graphite. In Comparative Example 3 to Comparative Example 10, the positive electrode lithium supplementing material and the positive electrode active material were mixed and a positive electrode current collector was coated with the mixture at a time.

A double-layer structure was used in Example 1 to Example 8, that is, the positive electrode lithium supplementing material layer was first applied as a coating, and then the positive electrode active material layer was applied. In Example 1 to Example 3, the negative electrode active material was silicon oxide, and Li₂FeO₄ applied onto the positive electrodes first accounted for about 1 wt %, 5 wt %, and 10 wt % of the positive electrode active material, respectively. In Example 4 to Example 6, the negative electrode active material was graphite, and Li₂FeO₄ applied onto the positive electrodes first accounted for about 1 wt %, 2 wt %, and 5 wt % of the positive electrode active material, respectively. In Example 7, the negative electrode active material was silicon oxide, and the positive electrode was coated first with Li₂NiO₂, which accounted for 10 wt % of the positive electrode active material. In Example 8, the negative electrode active material was graphite, and the positive electrode was coated first with Li₆Mn_{0.5}Ru_{0.5}O₄, which accounted for 4 wt % of the positive electrode active material.

As shown in Table 1, it can be known through comparison of results of the nail penetration tests that the nail penetration tests could be passed if the positive electrode lithium supplementing material was not added (for example, Comparative Example 1 to Comparative Example 2), or the positive electrode lithium supplementing material was directly mixed with the positive electrode active material and applied at a time (for example, Comparative Example 3 to Comparative Example 10). This is mainly because a nail caused an internal short circuit in the battery during nail penetration, and a local temperature increased sharply. When the local temperature exceeded the reaction temperature of the positive electrode active material, continuous chain reactions were caused and a large amount of heat was released, which eventually led to burning of the battery and might even cause explosion when burning is severe.

In contrast, the nail penetration performance implemented by using the double-layer structure is greatly improved. Example 1 to Example 8 can pass the nail penetration test with a pass rate of 100%. This is mainly because the positive electrode lithium supplementing material layer with which the current collector is coated generates in situ a layer of a delithiated product with stable properties and very low electronic conductivity in the first cycle of charging, which can effectively block conduction of a micro-short-circuit current during nail penetration, reduce a risk of thermal runaway, and enhance safety of the lithium-ion battery.

According to the method for preparing the positive electrode of this application, coating with the positive electrode lithium supplementing material layer and the positive electrode active material layer are respectively performed, and a particle size of the positive electrode lithium supplementing material and a thickness of the positive electrode lithium supplementing material layer are controlled, so that a polarization effect of the positive electrode lithium supplementing material layer on the lithium-ion battery is reduced. Li′ may be deintercalated after a volume phase of the material needs to undergo slow solid-phase diffusion. A larger particle size of the material and a longer ion transmission path mean poorer delithiation of the positive electrode lithium supplementing material. In this application, particles of the positive electrode lithium supplementing material are micronized, a solid-phase diffusion distance is shortened, and the polarization effect caused by too low ion conductivity is reduced. In addition, the positive electrode lithium supplementing material generates in situ a very poorly conductive product after delithiation, and a too thick positive electrode lithium supplementing material layer does not facilitate transport of electrons. In this application, a thickness of the positive electrode lithium supplementing material layer is controlled, and the positive electrode lithium supplementing material layer is rolled to strengthen contact between the particles, which better overcomes the polarization effect caused by the low electronic conductivity.

It can be known through comparison between Comparative Example 3 and Example 1, between Comparative Example 4 and Example 2, Comparative Example 5 and Example 3, between Comparative Example 6 and Example 4, between Comparative Example 7 and Example 5, between Comparative Example 8 and Example 6, between Comparative Example 9 and Example 7, and between Comparative Example 10 and Example 8, that during the first cycle of charging, delithiation capacities of the positive electrode lithium supplementing materials are almost the same.

It can be known through comparison of Comparative Example 3 to Comparative Example 10, Example 1 to Example 8, and Comparative Example 1 to Comparative Example 2, that regardless of whether one-time coating after mixing or double-layer structure coating is used, as long as the positive electrode lithium supplementing material is added, specific discharge capacity of the lithium-ion battery is greatly improved. This is mainly because lithium ions released by the positive electrode lithium supplementing material during charging can greatly supplement active lithium consumed by a negative electrode SEI film, thereby improving a reversible capacity and energy density of the lithium-ion battery.

In Comparative Example 3 to Comparative Example 5 and Example 1 to Example 3, a negative electrode of silicon oxide was used, and addition amounts of the positive electrode lithium supplementing materials Li₅FeO₄ thereof respectively accounted for about 1 wt %, 5 wt %, and 10 wt % the positive electrode active material. Based on a charging capacity of 188.5 mAh/g and first-cycle Coulombic efficiency of 96% of LiCoO₂, and first-cycle delithiation capacity of 600 mAh/g and first-cycle efficiency of 0% of the positive electrode lithium supplementing material, an ideal added amount of the positive electrode lithium supplementing material Li₅FeO₄ is about 4.96 wt % (corresponding to Comparative Example 4 and Example 2) of the positive electrode active material.

Similarly, in Comparative Example 6 to Comparative Example 8 and Example 4 to Example 6, a negative electrode of graphite was used, and addition amounts of the positive electrode lithium supplementing materials Li₅FeO₄ thereof respectively accounted for about 1 wt %, 2 wt %, and 5 wt % of the positive electrode active material. It can be known through the foregoing calculation that an optimal addition amount of the positive electrode lithium supplementing material is about 2.04 wt % (corresponding to Comparative Example 7 and Example 5).

When the positive electrode lithium supplementing material is added at the optimal percentage, a best lithium supplementing effect is achieved, and the reversible capacity and energy density of the lithium-ion battery are increased most greatly. When content percentage of the positive electrode lithium supplementing material is two low, a lithium source provided by the positive electrode lithium supplementing material is not enough to supplement active lithium consumed by the SEI film. When content percentage of the positive electrode lithium supplementing material is too high, a lithium source provided by the positive electrode lithium supplementing material is far more than enough, and some lithium is intercalated into the negative electrode active material during charging but cannot be utilized during discharging, which hinders improvement of the energy density.

In this application, a double-layer coating or deposition method is used, which can improve both the energy density and safety of the lithium-ion battery. This application features a simple process, is easy for commercial production, and has a great prospect of utilization.

According to the foregoing principles, in this application, appropriate changes and modifications may further be made to the foregoing implementations, for example, one or more of other lithium-rich oxide lithium supplementing materials are selected, or the positive electrode lithium supplementing material layer is obtained through deposition, or other positive electrode active materials, binders, and conductive agents are selected. Therefore, this application is not limited to the foregoing explained and described specific implementations, and some changes and modifications to this application shall also fall within the protection scope of the claims of this application.

References to “some embodiments”, “some of the embodiments”, “an embodiment”, “another example”, “examples”, “specific examples”, or “some examples” in the specification mean the inclusion of specific features, structures, materials, or characteristics described in the embodiment or example in at least one embodiment or example of this application. Accordingly, descriptions appearing in the specification, such as “in some embodiments”, “in the embodiments”, “in an embodiment”, “in another example”, “in an example”, “in a particular example”, or “for example”, are not necessarily references to the same embodiments or examples in this application. In addition, specific features, structures, materials, or characteristics herein can be combined in one or more embodiments or examples in any suitable manner.

Although illustrative embodiments have been demonstrated and described, those skilled in the art should understand that the foregoing embodiments are not to be construed as limiting this application, and that the embodiments may be changed, replaced, and modified without departing from the spirit, principle, and scope of this application.

What is claimed is:

1. A positive electrode lithium supplementing material, comprising: at least one of Li₂M1O₂, Li₂M2O₃, Li₅FeₓM3₁₋ₓO₄, or Li₆Mn_{y}M4_{1-y}O₄,
wherein M1 comprises at least one of Ni, Mn, Cu, Fe, Cr, or Mo;
M2 comprises at least one of Ni, Mn, Fe, Mo, Zr, Si, Cu, Cr, or Ru;
M3 comprises at least one of Al, Nb, Co, Mn, Ni, Mo, Ru, or Cr; and
M4 comprises at least one of Ni, Fe, Cu, or Ru;
wherein 0≤x≤1 and 0≤y≤1.

2. The positive electrode lithium supplementing material according to claim 1, wherein a first delithiation capacity of the positive electrode lithium supplementing material is greater than or equal to 300 mAh/g.

3. The positive electrode lithium supplementing material according to claim 1, wherein a median particle diameter D50 of the positive electrode lithium supplementing material is less than or equal to 1.5 μm.

4. The positive electrode lithium supplementing material according to claim 1, wherein the positive electrode lithium supplementing material comprises at least one of Li₂NiO₂, Li₂MoO₃, Li₅FeO₄, Li₅Fe_{0.9}Al_{0.1}O₄, Li₆MnO₄, or Li₆Mn_{0.5}Ru_{0.5}O₄.

5. A positive electrode, comprising: a positive electrode lithium supplementing material layer, the positive electrode lithium supplementing material layer comprises a positive electrode lithium supplementing material, wherein the positive electrode lithium supplementing material comprises at least one of Li₂M1O₂, Li₂M2O₃, Li₅FeₓM3₁₋ₓO₄, or Li₆Mn_{y}M4_{1-y}O₄,
wherein M1 comprises at least one of Ni, Mn, Cu, Fe, Cr, or Mo;
M2 comprises at least one of Ni, Mn, Fe, Mo, Zr, Si, Cu, Cr, or Ru;
M3 comprises at least one of Al, Nb, Co, Mn, Ni, Mo, Ru, or Cr; and
M4 comprises at least one of Ni, Fe, Cu, or Ru;
wherein 0≤x≤1 and 0≤y≤1.

6. The positive electrode according to claim 5, a thickness of the positive electrode lithium supplementing material layer being less than or equal to 10 μm.

7. The positive electrode according to claim 5, wherein the positive electrode lithium supplementing material layer further comprises a conductive agent and a binder,
wherein the binder comprises at least one of polypropylene, polyethylene, polyvinylidene fluoride, vinylidene fluoride-hexafluoropropylene, polytetrafluoroethylene, or polyhexafluoropropylene, and
the conductive agent comprises at least one of conductive carbon black, carbon fiber, acetylene black, Ketjen black, graphene, or a carbon nanotube.

8. The positive electrode according to claim 7, wherein based on a total weight of the positive electrode lithium supplementing material layer, a weight percentage of the positive electrode lithium supplementing material is 80 wt % to 90 wt %, a weight percentage of the binder is 5 wt % to 10 wt %, and a weight percentage of the conductive agent is 5 wt % to 10 wt %.

9. The positive electrode according to claim 5, further comprising a positive electrode active material layer, wherein the positive electrode lithium supplementing material layer is arranged on a current collector, and the positive electrode active material layer is arranged on the positive electrode lithium supplementing material layer.

10. The positive electrode according to claim 9, wherein the positive electrode active material layer comprises a positive electrode active material, a binder, and a conductive agent,
wherein the positive electrode active material comprises at least one of lithium cobalt oxide, lithium iron phosphate, lithium iron manganese phosphate, lithium vanadium phosphate, lithium vanadyl phosphate, lithium vanadate, lithium manganate, lithium nickelate, lithium nickel manganese cobalt oxide, lithium-rich manganese-based material, or lithium nickel cobalt aluminium oxide,
the binder comprises at least one of fluorine-containing resin, polypropylene resin, fiber-type binder, rubber-type binder, or polyimide-type binder, and
the conductive agent comprises at least one of conductive carbon black, carbon fiber, acetylene black, Ketjen black, graphene, or a carbon nanotube.

11. The positive electrode according to claim 10, wherein based on a total weight of the positive electrode active material layer, a weight percentage of the positive electrode active material is 80 wt % to 98 wt %, a weight percentage of the binder is 0.5 wt % to 10 wt %, and a weight percentage of the conductive agent is 0.5 wt % to 10 wt %.

12. The positive electrode according to claim 10, wherein the positive electrode lithium supplementing material in the positive electrode lithium supplementing material layer accounts for 1 wt % to 10 wt % of the positive electrode active material in the positive electrode active material layer.

13. A positive electrode, comprising: a positive electrode lithium supplementing material layer, the positive electrode lithium supplementing material layer comprises a delithiation product of the positive electrode lithium supplementing material, wherein the delithiation product of positive electrode lithium supplementing material comprises at least one of M1O, M2O₂, LiFeₓM3₁₋ₓO₂, or M4O₂,
wherein M1 comprises at least one of Ni, Mn, Cu, Fe, Cr, or Mo;
M2 comprises at least one of Ni, Mn, Fe, Mo, Zr, Si, Cu, Cr, or Ru;
M3 comprises at least one of Al, Nb, Co, Mn, Ni, Mo, Ru, or Cr; and
M4 comprises at least one of Ni, Fe, Cu, or Ru;
wherein 0≤x≤1.

14. An electrochemical apparatus, comprising the positive electrode according to claim 5.

15. An electrochemical apparatus, comprising the positive electrode according to claim 13.

16. An electronic apparatus, comprising the electrochemical apparatus according to claim 14.

17. An electronic apparatus, comprising the electrochemical apparatus according to claim 15.
